(19) United States
(12) Patent Application Publication
(10) Pub. No.: US 2019/0210462 A1
(43) Pub. Date: Jul. 11, 2019

(54) VEHICLE DISPLAY DEVICE

(71) Applicant: Toyota Jidosha Kabushiki Kaisha, Toyota-shi Aichi-ken (JP)

(72) Inventors: Akira Sasaki, Miyoshi-shi (JP); Eisuke Ando, Nagoya-shi (JP); Misako Hayashima, Okazaki-shi Aichi-ken (JP); Saki Kitoh, Okazaki-shi (JP); Masahiro Yamashita, Seto-shi (JP)

(21) Appl. No.: 16/233,354

(22) Filed: Dec. 27, 2018

(30) Foreign Application Priority Data
Jan. 9, 2018 (JP) 2018-001359

(51) Int. Cl. B60K 35/00; B60W 50/14; B60W 50/08

(52) U.S. Cl. CPC B60K 35/00; B60W 50/14; B60W 50/082; B60K 2350/1004; B60K 2350/352; B60K 2350/1028; B60W 2050/146

(57) ABSTRACT

A vehicle display device includes: a switch section configured to switch a vehicle between automated driving and manual driving; a display section capable of displaying information related to driving assistance and information unrelated to driving assistance on a display region; and a controller that, in a case in which manual driving has been switched to automated driving by the switch section, controls so as to change a display state of the related information on the display section such that the related information is less visible than the unrelated information.

### CROSS-REFERENCE TO RELATED APPLICATION

This application is based on and claims priority under 35 USC 119 from Japanese Patent Application No. 2018-001359 filed on Jan. 9, 2018, the disclosure of which is incorporated by reference herein.

### BACKGROUND

### Technical Field

The present disclosure relates to a vehicle display device.

### Related Art

Japanese Patent Application Laid-Open (JP-A) No. 2017-154542 discloses a driving switching device which is switched from automated driving in which a vehicle drives itself to manual driving by a driver in cases in which determination has been made that the vehicle has entered a state in which automated driving should be ended.

Vehicle display devices are proposed that assist manual driving by displaying information related to driving assistance (such as vehicle speed information, amount of fuel remaining information, and lane-keeping information) on a display section. In vehicles capable of switching between manual driving and automated driving and provided with such a vehicle display device, if the information related to driving assistance continues to be displayed by the display section during automated driving, information unrelated to driving assistance becomes difficult to check on the display section. Namely, there is room for improvement with regards to facilitating checking of information unrelated to driving assistance during automated driving.

### SUMMARY

In consideration of the above circumstances, the present disclosure provides a vehicle display device enabling information unrelated to driving assistance to be more easily checked during automated driving.

An aspect of the present disclosure is a vehicle display device includes a switch section configured to switch a vehicle between automated driving and manual driving; a display section capable of displaying information related to driving assistance and information unrelated to driving assistance on a display region; and a controller that, in a case in which manual driving has been switched to automated driving by the switch section, controls so as to change a display state of the related information on the display section such that the related information is less visible than the unrelated information.

In the vehicle display device according to the aspect, both the information related to driving assistance and the information unrelated to driving assistance may be displayed on the display section. In cases in which manual driving has been switched to automated driving by the switch section, the controller controls so as to change a display state of the related information on the display section such that the related information is less visible than the unrelated information. The unrelated information is accordingly relatively more visible on the display section than the related information, thereby facilitating checking of information unrelated to driving assistance during automated driving. Note that “the related information is less visible” refers to the related information being relatively less visible to an occupant than the unrelated information. Namely, “the related information is less visible” refers not only to cases in which the occupant is unable to see the related information at all, but also to cases in which the unrelated information is more clearly noticed by the occupant than the related information, although the related information is also visible to the occupant.

The vehicle display device according to the present aspect may be configured such that, in a case in which manual driving has been switched to automated driving by the switch section, the controller controls to as to make a display region of the related information on the display section smaller than a display region of the related information on the display section prior to automated driving being detected.

In the above configuration, the display region of the related information is made smaller than the display region of the related information prior to automated driving being detected. The unrelated information is accordingly made relatively larger on the display section than the related information, facilitating checking of the unrelated information.

The vehicle display device according to the present aspect may be configured such that, in a case in which manual driving has been switched to automated driving by the switch section, the controller controls so as to shift a display position of the related information on the display section with respect to a display position of the related information on the display section prior to automated driving being detected.

In the above configuration, the display position of the related information is shifted with respect to the display position of the related information prior to automated driving being detected. The unrelated information is accordingly relatively more visible on the display section than the related information, facilitating checking of the unrelated information.

The vehicle display device according to the present aspect may be configured such that, in a case in which manual driving has been switched to automated driving by the switch section, the controller controls so as to lower a display density of the related information on the display section compared to a display density of the related information on the display section prior to automated driving being detected.

In the above configuration, the display density of the related information is lowered compared to the display density of the related information prior to the detection of automated driving. The display density of the unrelated information on the display section become accordingly relatively higher than the display density of the related information, facilitating checking of the unrelated information.

The vehicle display device according to the present aspect may be configured such that the display region includes a first display region where at least one of the related information or the unrelated information is capable of being displayed, and a second display region where the unrelated information is displayed; and in a case in which manual driving has been switched to automated driving by the switch section, the controller controls so as to expand display of the unrelated information from display in the second display region to also being displayed in the first display region.

In the above configuration, in cases in which manual driving has been switched to automated driving by the switch section, the controller expands the display region of the unrelated information from the second display region to the first display region. The display region of the unrelated information is accordingly made relatively larger than that of the related information on the display section, facilitating checking of the unrelated information.

The vehicle display device according to the present aspect may be configured such that the display section includes a touch panel that includes the display region, and that outputs designating information designating a touched location; and in a case in which manual driving has been switched to automated driving by the switch section and the designating information has been input to the controller from a location where the related information is displayed on the touch panel, the controller controls so as to interrupt display at the location where the related information is being displayed.

In the above configuration, in cases in which manual driving has been switched to automated driving by the switch section and the designating information has been input from a location where the related information is displayed on the touch panel, the controller interrupts display of the related information corresponding to the designating information. Since display of related information is maintained at locations where the designating information has not been input, if there is any related information that is necessary to the occupant, this necessary related information is able to be checked even without canceling automated driving.

The vehicle display device according to the present aspect may be configured such that, in a case in which automated driving has been switched to manual driving by the switch section, the controller controls so as to change a display state of the related information on the display section such that the related information during manual driving is more visible than the related information during automated driving.

In the above configuration, in cases in which automated driving has been switched to manual driving, the related information is made more visible than the related information displayed during automated driving. The related information is accordingly more easily ascertained in cases in which automated driving has been switched to manual driving, enabling the driver to be prevented from being confused in manual driving.

As explained above, the technology of the present disclosure enables information unrelated to driving assistance to be more easily checked during automated driving.

### BRIEF DESCRIPTION OF THE DRAWINGS

FIG. 1 is an explanatory diagram illustrating a state in which information is displayed on a front windshield by a vehicle display device according to a first exemplary embodiment;

FIG. 2 is a block diagram of a vehicle, including configuration of the vehicle display device according to the first exemplary embodiment;

FIG. 3 is an explanatory diagram illustrating a state in which related information and unrelated information are displayed in a display region according to the first exemplary embodiment;

FIG. 4 is an explanatory diagram illustrating a state in which unrelated information is displayed in the display region whereas the display of related information is made smaller in the first exemplary embodiment;

FIG. 5 is a flowchart illustrating a flow of processing in which a display state of related information is changed in the vehicle display device according to the first exemplary embodiment;

FIG. 6A is an explanatory diagram illustrating a state in which information is displayed on a touch panel by a vehicle display device according to a second exemplary embodiment;

FIG. 6B is an explanatory diagram illustrating a state in which, according to the second exemplary embodiment, display has been interrupted of related information selected by the touch panel;

FIG. 7 is a flowchart illustrating a flow of processing in which a display state of related information is changed in the vehicle display device according to the second exemplary embodiment;

FIG. 8 is an explanatory diagram illustrating a state in which unrelated information is expanded for display over an entire display region of a vehicle display device according to a third exemplary embodiment;

FIG. 9 is an explanatory diagram illustrating a state in which unrelated information is displayed and display of related information has been dimmed in a display region according to a first modified example;

FIG. 10 is an explanatory diagram illustrating a state in which unrelated information is displayed and display of related information has been cleared in a display region according to a second modified example; and

FIG. 11 is an explanatory diagram illustrating a state in which plural different items of unrelated information are displayed in a display region according to a third modified example.

### DETAILED DESCRIPTION

### First Exemplary Embodiment

Explanation follows regarding a vehicle 10 and a vehicle display device 40 of a first exemplary embodiment. Note that in the drawings, FR indicates the front of a vehicle (the direction of travel), the arrow UP indicates the vehicle upper side, and the arrow OUT indicates the vehicle width direction outer side.

Overall Configuration

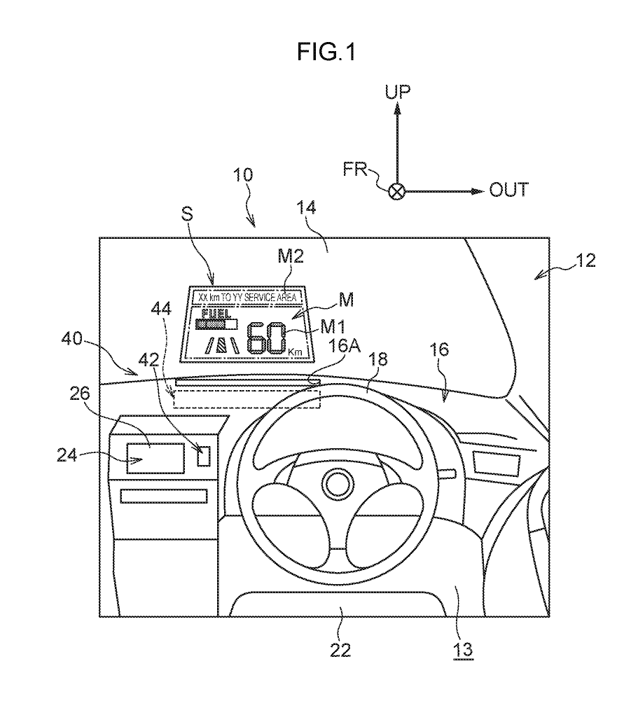

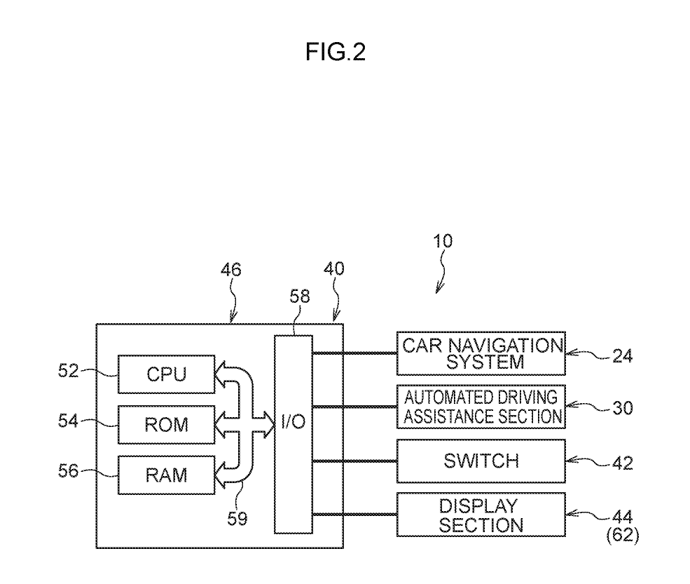

The vehicle 10 illustrated in FIG. 1 is configured including a vehicle body 12, a front windshield 14, an instrument panel 16, a steering apparatus 18, a seat 22, a car navigation system 24, an automated driving assistance section 30 (see FIG. 2), and the vehicle display device 40. The vehicle body 12 includes a vehicle cabin 13.

The front windshield 14 is provided at the front of the interior of the vehicle cabin 13. A non-illustrated occupant (driver) seated in the seat 22 is able to view the scene ahead of the vehicle 10 through the front windshield 14. An opening 16A is formed in an upper face of the instrument panel 16 so as to open toward the front windshield 14.

The car navigation system 24 includes an operating panel 26. The operating panel 26 is provided at a location on the instrument panel 16 visible to and operable by the driver. Plural selectable buttons, not illustrated in the drawings, are displayed on the operating panel 26. The driver selects operation and actuates the car navigation system 24 by pressing one of the buttons. Note that in the example of the first exemplary embodiment operations performed using the buttons of the operating panel 26 include the operation of each section of the vehicle 10.

A non-illustrated transceiver, including a receiver antenna and a transmitter antenna, and a hard disk, are connected to the car navigation system 24. The transceiver of the car navigation system 24 is capable of receiving image data, audio data, and other information (text data such as messages) transmitted via a network. A received or selected data signal is transmitted to an ECU 46 (see FIG. 2), described later. Information regarding the proximity of the vehicle 10 (such as information regarding the distance to a nearby service area (SA), and the operational state of various facilities and any souvenirs that are available at the service area) is included in the various information obtained by the transceiver.

The automated driving assistance section 30 illustrated in FIG. 2 is configured so as to ascertain the situation of the vehicle itself and its surroundings based on information obtained from various sensors, not illustrated in the drawings, and so as to perform automated driving control processing to control an amount of acceleration, amount of braking, steering angle, and so on, in order to drive the vehicle 10 automatically. In other words, the driving state of the vehicle 10 enters an automated driving state when the automated driving assistance section 30 is actuated. The driving state of the vehicle 10 enters a manual driving state manually operated by the driver when actuation of the automated driving assistance section 30 is stopped.

The various sensors for automatically driving the vehicle 10 include external sensors and internal sensors. The external sensors include at least one of a camera, radar, or laser imaging detection and ranging (LIDAR) sensor, and detect the situation in the surroundings of the vehicle 10. The internal sensors include at least of a vehicle speed sensor, an acceleration sensor, and a yaw rate sensor, and detect the vehicle situation, such as a driving state, by detecting various physical quantities while the vehicle 10 is traveling.

Configuration of Relevant Portions

Explanation follows regarding the vehicle display device 40.

The vehicle display device 40 illustrated in FIG. 2 includes a switch 42 serving as an example of a switch section, a display section 44 serving as an example of a display section, and the electronic control unit (ECU) 46 serving as an example of a controller.

Switch

The switch 42 illustrated in FIG. 1 is provided at a location on the instrument panel 16 operable by an occupant (i.e., a driver). The switch 42 is, for example, configured so as to be set to an ON state by being pressed, and set to an OFF state by being pressed again. This thereby switches the vehicle 10 between automated driving and manual driving. In order to prevent the ON state and the OFF state from being mistaken for each other, a non-illustrated illumination portion is provided to the switch 42 to illuminate the switch 42 in different colors when in the ON state and when in the OFF state. Information regarding the ON state and the OFF state of the switch 42 is sent to the ECU 46 (see FIG. 2), described later.

Display Section

As an example, the display section 44 illustrated in FIG. 1 is built into the instrument panel 16. Specifically, the display section 44 is configured including a light source, a liquid crystal panel, and a reflector, not illustrated in the drawings. Note that the display section 44 includes the front windshield 14 in the first exemplary embodiment. The display section 44 is driven under control of the ECU 46 (see FIG. 2), described later. Specifically, the driving of the liquid crystal panel is controlled according to information M to be displayed. Light that has been transmitted through the liquid crystal panel and reflected by the reflector is illuminated onto the front windshield 14, thereby enabling the information M to be displayed in a preset display region S on the front windshield 14.

The information M includes text information and graphical information. The content of the information M includes information relating to driving assistance for the vehicle 10 (hereafter referred to as related information M1) and information unrelated to driving assistance for the vehicle 10 (hereafter referred to as unrelated information M2). In the first exemplary embodiment, an example of the related information M1 includes information about the speed of the vehicle 10, information about the amount of fuel remaining in the vehicle 10, and information about lane keeping of the vehicle 10. An example of the unrelated information M2, in the first exemplary embodiment, includes information regarding the distance from the vehicle 10 to the nearest service area (SA), information regarding the operational state of various facilities at the service area, and information regarding any souvenirs available at the service area.

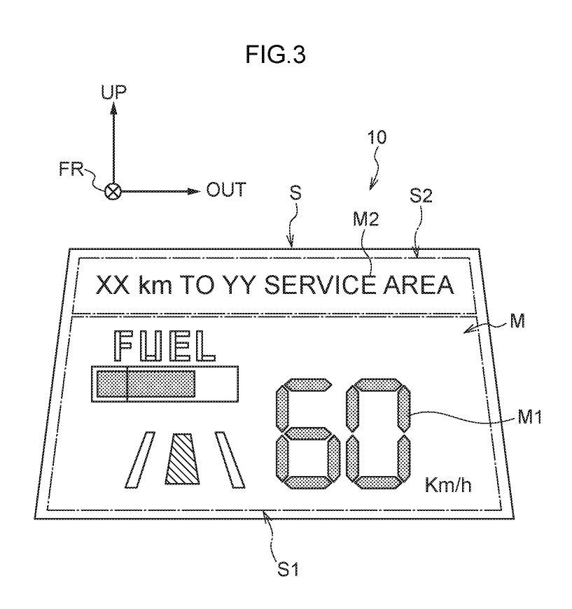

As in the example illustrated in FIG. 3, the display region S is formed in an isosceles trapezoid shape when viewed face-on. As an example, the interior of the display region S is divided into a first display region S1 and a second display region S2. The first display region S1 is set at locations encompassing a height direction (vehicle vertical direction) center of the display region S and locations below the center. In the first exemplary embodiment, the related information M1 is basically displayed in the first display region S1, but in some circumstances the unrelated information M2 is displayed in the first display region S1. In the example in FIG. 3, the speed of the vehicle 10 is displayed as being 60 km/h, the amount of fuel remaining is displayed in the form of a bar, and the state of lane keeping is displayed as being at substantially the center of the vehicle lane.

As an example, the second display region S2 is set at a location at the upper side of the height direction center of the display region S. The surface area of the second display region S2 is smaller than the surface area of the first display region S1. In the first exemplary embodiment, the unrelated information M2 is configured to be displayed in the second display region S2. As an example, the distance to the nearest service area is displayed as the unrelated information M2.

ECU

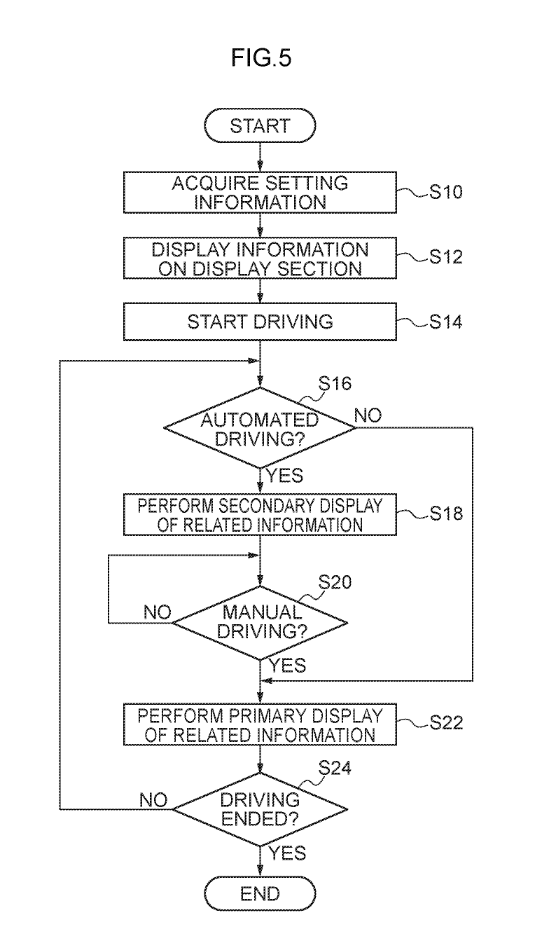

The ECU 46 illustrated in FIG. 2 is configured by a computer in which a central processing unit (CPU) 52, read only memory (ROM) 54, random access memory (RAM) 56, and an input/output interface (I/O) 58 are connected together through a bus 59. The ECU 46 controls driving of each section of the vehicle 10 and controls so as to operate each section electrically connected to the ECU 46. Note that a program to perform processing according to a flowchart (see FIG. 5), described later, is installed in the ECU 46. The program is stored in the ROM, RAM, or other memory, for example. The car navigation system 24, the automated driving assistance section 30, the switch 42, and the display section 44 are connected to the ECU 28 via the I/O 58.

In cases in which manual driving has been switched to automated driving by the switch 42, the ECU 46 controls such that a display state of the related information M1 on the display section 44 is changed to display the related information M1 in the display region S (see FIG. 1) so as to be less visible than the unrelated information M2. In cases in which automated driving has been switched to manual driving by the switch 42, the ECU 46 controls to change the display state of the related information M1 on the display section 44 to display the related information M1 more visibly during manual driving than the visibility of the related information M1 during automated driving. A sensor that detects a rotation state of an ignition key, not illustrated in the drawings, is connected to the ECU 46. The ECU 46 thereby detects the start of driving the vehicle 10 and the finish of driving the vehicle 10.

There are, for example, three modes set in the ECU 46 as display control modes of the information M (see FIG. 1) on the display section 44 for cases in which manual driving has been switched to automated driving. These are a reduced size mode, a shifted position mode, and a lower density mode. Note that in the first exemplary embodiment, as an example, the program installed in the ECU 46 is configured to execute the reduced size mode, the shifted position mode, and the lower density mode altogether.

Reduced Size Mode

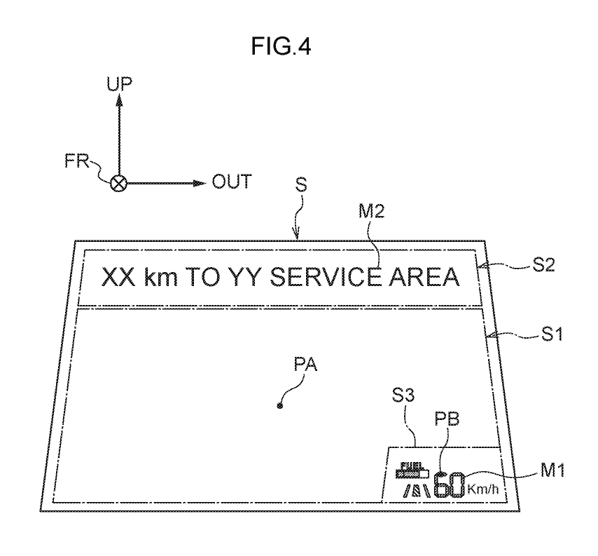

The reduced size mode is a mode for, in cases in which manual driving has been switched to automated driving by the switch 42, controlling such that the display region of the related information M1 on the display section 44 is reduced compared to the display region of the related information M1 prior to automated driving being detected. Specifically, control is performed such that the surface area of a display region of the related information M1 during automated driving (hereafter referred to as a display region S3, see FIG. 4) is reduced compared to the surface area of the display region of the related information M1 during manual driving (the first display region S1, see FIG. 3). In the first exemplary embodiment the surface area of the display region S3 is, as an example, made to be approximately one fifteenth the surface area of the first display region S1.

Shifted Position Mode

The shifted position mode is a mode for, in cases in which manual driving has been switched to automated driving by the switch 42, controlling such that the display position of the related information M1 on the display section 44 is shifted from the display position prior to automated driving being detected. Specifically, as illustrated in FIG. 4, a position PA is a central position of the first display region S1 in both the height direction (i.e., vehicle vertical direction) of the first display region S1 and also in a width direction (i.e., vehicle width direction) thereof, orthogonal to the height direction. A position PB is a central position of the display region S3, on which the related information M1 is displayed during automated driving, in both the height direction and the width direction of the display region S3. The ECU 46 (see FIG. 2) controls so as to shift the center of the display position of the related information M1 from the position PA to the position PB. In the first exemplary embodiment setting is made such that, as an example, the position PB is shifted toward the lower right side with respect to the position PA, when viewing the display region S face-on (in the direction of travel).

Lower Density Mode

In the vehicle display device 40 illustrated in FIG. 2, the lower density mode is a mode for, in cases in which manual driving has been switched to automated driving, controlling such that the density for displaying the related information M1 on the display section 44 is lowered compared to the display density prior to automated driving being detected. In the first exemplary embodiment the density for displaying the related information M1 during automated driving is, as an example, a density that is barely visible, in contrast to the clearly visible density for displaying the related information M1 during manual driving. Note that the lowered density to display the related information M1 includes a zero density state (i.e., the related information is cleared).

Operation and Effects

Explanation follows regarding operation and effects of the vehicle display device 40 of the first exemplary embodiment, with reference to the flowchart in FIG. 5. FIG. 1 to FIG. 4 will be referenced regarding each section of the vehicle 10. A program for performing the processing of the flowchart in FIG. 5 is loaded from memory into a processor (the CPU in this case), and the processor functions as the controller by executing the program.

At step S10, a display setting for the related information M1 is prepared for use in cases in which manual driving has been switched to automated driving by the occupant (driver) using the operating panel 26. In other words, information relating to the display settings is acquired by the ECU 46. An example of a display setting for the related information M1 is a display setting selecting the reduced display region mode, the shifted display position mode, and the lower density mode. The selected settings are stored in the ECU 46. Processing then transitions to step S12.

At step S12, the related information M1 and the unrelated information M2 are displayed on the display section 44 (display region S), and the processing then transitions to step S14. At this time, the surface area of the display region for the related information M1 is larger than that for the unrelated information M2 and, therefore, the related information M1 is displayed in a state that is more visible (stands out more) than the unrelated information M2. In the following explanation, a display state in which the related information M1 is more visible than the unrelated information M2 is referred to as a primary display state. A display state in which the related information M1 is less visible than the unrelated information M2 is referred to as a secondary display state.

At step S14, driving of the vehicle 10 is started by the non-illustrated accelerator pedal being operated in the manual driving state. At this time, the related information M1 is in the primary display state, and the driver may easily ascertain the amount of fuel remaining, the speed of the vehicle 10, and the lane keeping status. Processing then transitions to step S16.

At step S16, determination is made as to whether or not automated driving is selected. Specifically, automated driving is determined to be selected in cases in which the switch 42 is in the ON state, and processing transitions to step S18. Manual driving is determined to be selected in cases in which the switch 42 is in the OFF state, and in this case processing transitions to step S22.

At step S18, the related information M1 is displayed in the secondary display state. Specifically, the surface area of the related information M1, which has been displayed in the first display region S1, is reduced to a surface area smaller than the surface area of the second display region S2 where the unrelated information M2 is being displayed. Further, the related information M1 is shifted so as to be disposed at the lower right of the first display region S1. The density for displaying the related information M1 is also lowered compared to the density of the original display. Specifically, the display state of the related information M1 is changed to the display state illustrated in FIG. 4. Setting the related information M1 in the secondary display state in this manner makes the unrelated information M2, which is useful during automated driving, more visible to the occupant than the related information M1, which is not required during automated driving. Processing then transitions to step S20 illustrated in FIG. 5.

At step S20, determination is made as to whether or not manual driving has been selected. Specifically, manual driving is determined to be selected (i.e., determination is affirmative) in cases in which the switch 42 is in the OFF state, and processing transitions to step S22. This determination as to whether or not manual driving has been selected is repeated while the switch 42 is still in the ON state.

At step S22, the related information M1 is displayed in the primary display state. In other words, the display state of the related information M1 is returned to its original state (i.e., the state when driving started). Specifically, the surface area for displaying the related information M1 is made greater than the surface area for displaying the unrelated information M2, the related information M1 is centered on the position PA of the first display region S1, and the density for displaying the related information M1 is returned to the original display density. Displaying the related information M1 in the primary display state in this manner makes the related information M1, which provides driving assistance during manual driving, more visible to the occupant. Processing then transitions to step S24.

At step S24, determination is made as to whether or not driving of the vehicle 10 has ended by detecting a rotation state of the non-illustrated ignition key. The program is ended in cases in which driving has ended. Processing transitions to step S16 in cases in which driving is ongoing.

As explained above, in cases in which manual driving has been switched to automated driving by the switch 42, the ECU 46 in the vehicle display device 40 controls so as to change the display state of the related information M1 on the display section 44 such that the related information M1 is less visible than the unrelated information M2. The unrelated information M2 is accordingly relatively more visible on the display section 44 than the related information M1, thereby enabling the unrelated information M2 to be more easily checked during automated driving.

In the vehicle display device 40, the display region S3 for the related information M1 is smaller than when it has been displayed in the first display region S1 prior to automated driving being detected. The unrelated information M2 is accordingly relatively larger on the display section 44 than the related information M1, thereby facilitating checking of the unrelated information M2.

In the vehicle display device 40, the display position of the related information M1 is shifted or moved from to the display position prior to automated driving being detected. The unrelated information M2 is accordingly disposed relatively nearer to the center of the display section 44 than the related information M1, making the unrelated information M2 more visible, and thereby facilitating checking of the unrelated information M2.

In addition, the density for displaying the related information M1 on the vehicle display device 40 is lowered compared to the display density prior to automated driving being detected. The display density of the unrelated information M2 on the display section 44 is thereby relatively higher than the density for displaying the related information M1, facilitating checking of the unrelated information M2.

In the vehicle display device 40, in cases in which automated driving has been switched to manual driving, the related information M1 is made more visible than the related information M1 displayed during automated driving. Thus, the related information M1 is more easily ascertained in cases in which automated driving has been switched to manual driving, enabling the driver to be suppressed from being confused in manual driving.

### Second Exemplary Embodiment

Explanation follows regarding a vehicle display device 60 according to a second exemplary embodiment. Note that members, locations, and processing basically similar to those in the first exemplary embodiment described above are appended with the same reference numerals as in the first exemplary embodiment, and explanation thereof is omitted.

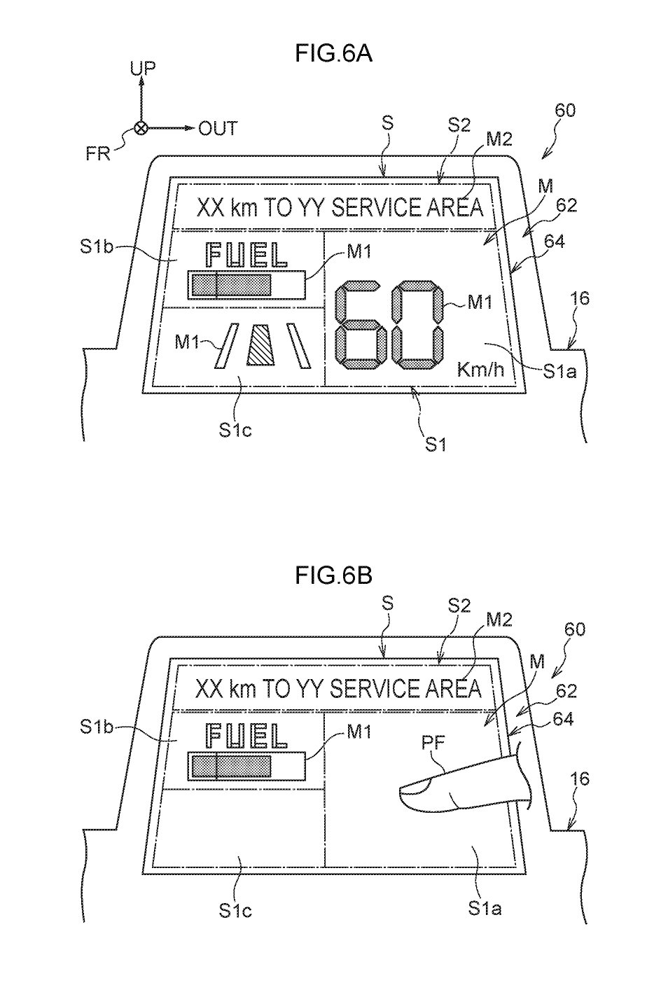

The vehicle display device 60 of the second exemplary embodiment illustrated in FIG. 6A is provided with a display section 62, serving as an example of a display section, instead of the display section 44 of the vehicle display device 40 of the first exemplary embodiment (see FIG. 2). Part of the processing program installed in the ECU 46 (see FIG. 2) also differs in the vehicle display device 60. Configuration other than that of the ECU 46 and the display section 62 is basically the same as the configuration of the vehicle display device 40, and so explanation thereof is omitted.

As an example, the display section 62 includes a touch panel 64 provided to the instrument panel 16. As an example, the touch panel 64 is disposed at the vehicle vertical direction upper side of the operating panel 26 (see FIG. 1). Driving of the touch panel 64 is controlled by the ECU 46 (see FIG. 2). The touch panel 64 includes the display region S including the first display region S1 and the second display region S2, and is configured to be capable of displaying the related information M1 and the unrelated information M2. The touch panel 64 is configured to output designating information designating a location touched by an occupant finger PF (see FIG. 6B) to the ECU 46. The designating information corresponds to position information indicating which location (region) of the touch panel 64 has been touched.

As an example, the first display region S1 is divided into a speed display region S1a where speed information is displayed, a fuel display region S1b where the amount of fuel remaining is displayed in the form of a bar, and a lane display region S1c where lane-keeping information is displayed. Note that division into the speed display region S1a, the fuel display region S1b, and the lane display region S1c is a virtual division set by the program.

The speed display region S1a, the fuel display region S1b, and the lane display region S1c are each set on the touch panel 64 as individual independent units. Namely, the touch panel 64 is configured such that when the touch panel 64 is touched by a finger PF, the designating information for each particular region is output (individually) to the ECU 46. Moreover, on the touch panel 64, display at the location corresponding to the output designating information is switched to a displayed state or an interrupted display state under the control of the ECU 46. Switching between the displayed state and the interrupted display state is performed every time the touch panel 64 is touched by a finger PF.

In cases in which manual driving has been switched to automated driving by the switch 42 (see FIG. 2) and designating information has been input to the ECU 46 for a region where the related information M1 is being displayed on the touch panel 64, the ECU 46 controls to interrupt display in the corresponding region where the related information M1 is being displayed. For example, as illustrated in FIG. 6B, the finger PF of the occupant may touch the speed display region S1a and the lane display region S1c during automated driving. In such cases, the displays of the related information M1 in the speed display region S1a and the lane display region S1c are interrupted (cleared), such that only the display of the fuel bar remains in the fuel display region S1b. Note that in cases in which a region other than the desired region for clearing the related information M1 has been mistakenly 1 touched by a finger PF, this information may be re-displayed by touching the same region again with the finger PF.

Operation and Effects

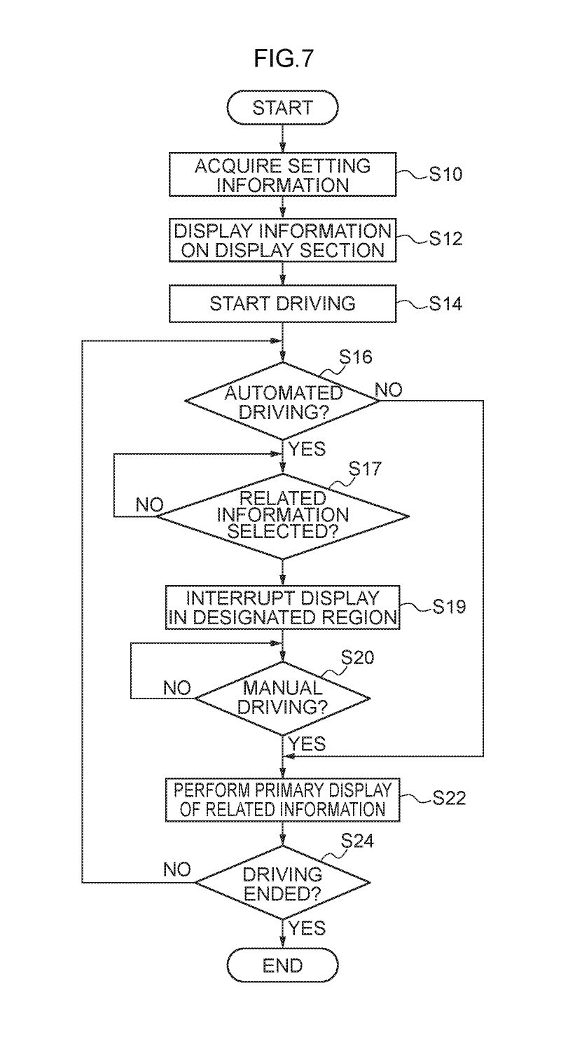

Explanation follows regarding operation and effects of the vehicle display device 60 of the second exemplary embodiment, with reference to the flowchart in FIG. 7. A program for performing the processing of the flowchart in FIG. 7 is loaded from memory into a processor (the CPU in this case) and the processor functions as the controller by executing the program. Note that FIG. 2, FIG. 6A, and FIG. 6B will be referenced regarding the vehicle 10. Similar steps (processing) to those in the first exemplary embodiment are appended with the same reference numerals as in the first exemplary embodiment, and explanation thereof may be omitted.

At step S10, a display setting (mode selection) is prepared for the related information M1 for cases in which manual driving has been switched to automated driving by the occupant (driver) using the operating panel 26. In other words, information relating to the display setting is acquired by the ECU 46. As an example of the display setting, a partial clear mode setting for clearing at least one region of the speed display region S1a, the fuel display region S1b, or the lane display region S1c may be selected. The selected setting is stored in the ECU 46, and the processing then transitions to step S12.

Step S12 and step S14 are similar to those in the first exemplary embodiment, and the processing then transitions to step S16.

At step S16, determination is made as to whether or not automated driving is selected. Specifically, automated driving is determined to be selected in cases in which the switch 42 is in the ON state, and processing transitions to step S17. Manual driving is determined to be selected in cases in which the switch 42 is in the OFF state, and in this case processing transitions to step S22.

At step S17, the touch panel 64 determines whether or not at least one region of the speed display region S1a, the fuel display region S1b, or the lane display region S1c has been touched (operated). In other words, determination is made as to whether or not at least one item of related information M1 of the speed information, the amount of fuel remaining information, or the lane-keeping information has been selected. In cases in which at least one item of related information M1 has been selected, processing transitions to step S19. When all the items of related information M1 remain unselected, the determination as to whether or not at least one item of related information M1 has been selected is repeated.

At step S19, display is interrupted for the one or more regions selected from the speed display region S1a, the fuel display region S1b, or the lane display region S1c. In other words, display in the designated region is interrupted by the ECU 46, such that the related information M1 is displayed in a secondary display state. Displaying the related information M1 in the secondary display state in this manner makes the unrelated information M2 more visible to an occupant instead of the related information M1. Display of the related information M1 is maintained for unselected regions. Processing then transitions to step S20.

Step S20, step S22, and step S24 are similar to those in the first exemplary embodiment, and the program is then ended.

As explained above, switching to automated driving may be performed in the vehicle display device 60 by the switch 42, and designating information may be input from locations on the touch panel 64 where the related information M1 is being displayed. The ECU 46 then interrupts display of the related information M1 corresponding to the designating information. Specifically, for example, display of speed information in the speed display region S1a and display of lane-keeping information in the lane display region S1c are interrupted when selected by the occupant. Thus, display is only maintained of the amount of fuel remaining information in the fuel display region S1b in this case, that is a region where designating information has not been input. This thereby enables the amount of fuel remaining information to be checked when amount of fuel remaining information is required by the occupant, even without canceling automated driving.

### Third Exemplary Embodiment

Explanation follows regarding a vehicle display device 70 according to a third exemplary embodiment. Note that members, locations, and processing that are basically similar to those in the first exemplary embodiment described above are appended with the same reference numerals to those of the first exemplary embodiment, and explanation thereof is omitted.

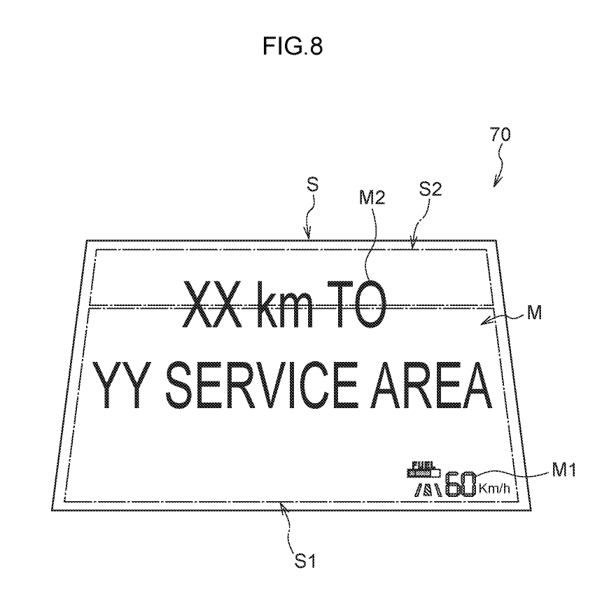

The vehicle display device 70 of the third exemplary embodiment illustrated in FIG. 8 is configured with a display region S of the vehicle display device 40 (see FIG. 2) including a first display region S1 capable of displaying at least one of the related information M1 or the unrelated information M2, and a second display region S2 that only displays the unrelated information M2.

The vehicle display device 70 is configured to as to perform size reduction processing, position shifting processing, and density lowering processing on the related information M1 in cases in which manual driving has been switched to automated driving by the switch 42 (see FIG. 2). In the vehicle display device 70, the ECU 46 (see FIG. 2) effects control of displaying the unrelated information M2 expanded from the second display region S2 in the first display region S1 in cases in which manual driving has been switched to automated driving.

Operation and Effects

Explanation follows regarding operation and effects of the vehicle display device 70 of the third exemplary embodiment.

In the vehicle display device 70, in cases in which manual driving has been switched to automated driving by the switch 42 (see FIG. 2), the ECU 46 (see FIG. 2) reduces the size of the related information M1, shifts the position of the related information M1, and lowers the display density of the related information M1. The related information M1 is thereby displayed at a smaller size at the lower right (right corner) of the first display region S1. The ECU 46 also displays the unrelated information M2 expanded from the second region S2 to also being displayed in the first display region S1 (i.e., displayed across these regions). The size of the unrelated information M2 on the display section 44 (see FIG. 2) is thereby made relatively larger than the related information M1, facilitating checking of the unrelated information M2.

The present disclosure is not limited to the above exemplary embodiments.

### First Modified Example

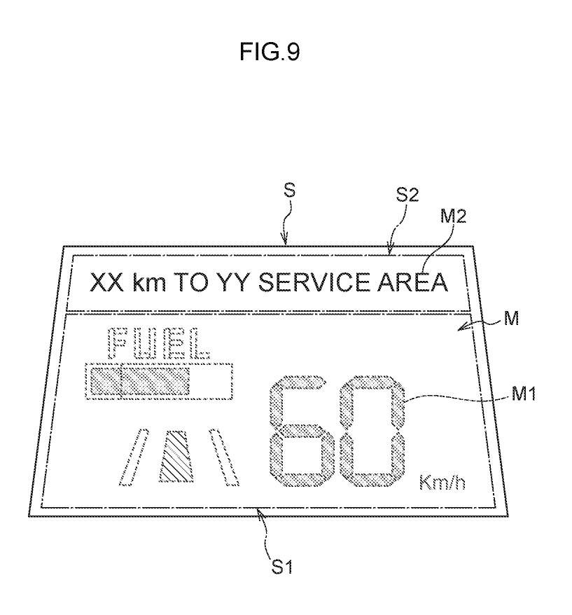

As illustrated in FIG. 9, configuration may be such that only the density of the related information M1 is lowered without changing the size or the position thereof in the first display region S1 in cases in which manual driving has been switched to automated driving.

### Second Modified Example

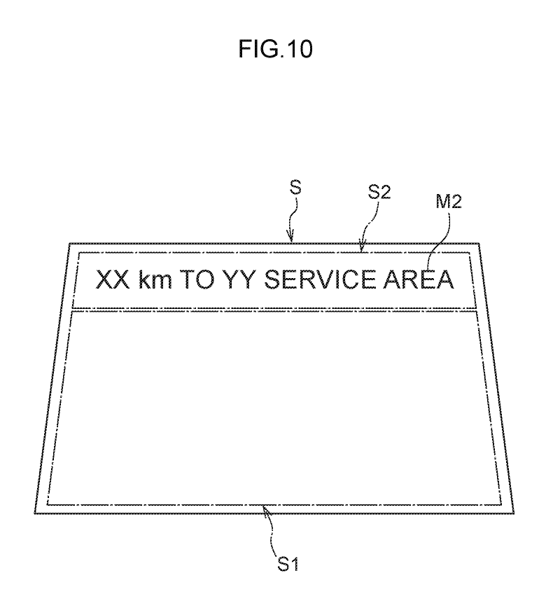

As illustrated in FIG. 10, configuration may be such that all the related information M1 in the first display region S1 is cleared in cases in which manual driving has been switched to automated driving.

### Third Modified Example

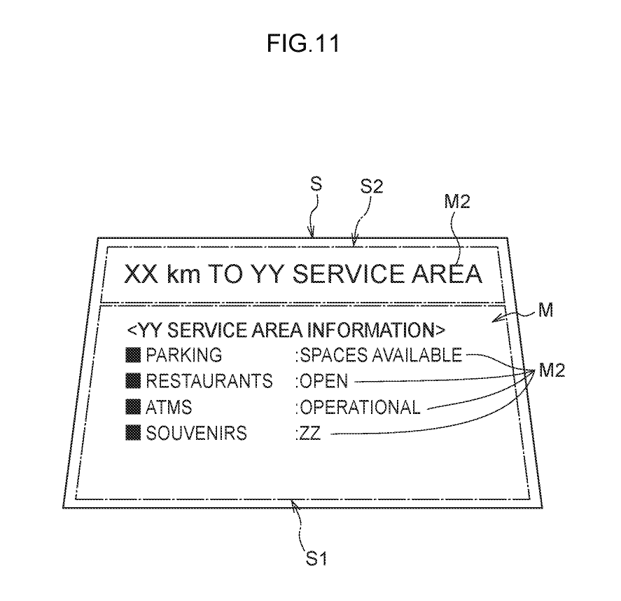

As illustrated in FIG. 11, configuration may be such that the second display region S2 remains as it is, and other unrelated information M2 (different from the information in the second display region S2) is displayed in the first display region S1 instead of the related information M1 in cases in which manual driving has been switched to automated driving. In FIG. 11, parking information, restaurant information, ATM operating information, and souvenir information for the nearest service area are illustrated as an example of other unrelated information M2.

### Other Modified Examples

In the vehicle display device 40, a combination of settings for the reduced size mode, the shifted position mode, and the lower density mode is not limited to a configuration in which the three modes are set altogether. A configuration may be applied in which any one mode thereof is set, or a configuration may be applied in which any two modes thereof are set. The size to which the related information M1 is reduced in the reduced size mode is not limited to one fifteenth of the original size, and any other ratio may be applied. The direction to shift the related information M1 in the shifted position mode is not limited to being the vehicle width direction, and may be the vehicle vertical direction.

The switch 42 is not limited to a switch mechanically switched between the ON and OFF states and may, for example, be configured by a button operated on a touch panel.

The display section 44 is not limited to being provided to the instrument panel 16 and may, for example, be configured by a projector provided inside the vehicle cabin 13.

The information that remains being displayed on the vehicle display device 60 is not limited to the information regarding fuel, and may be the speed information or the lane-keeping information.

In the vehicle display device 70, the related information M1 may be cleared in the state in which the unrelated information M2 has been expanded.

The related information M1 displayed on the front windshield glass 14 and the touch panel 64 is not limited to the fuel-related information, the speed information, and the lane-keeping information. For example, other information, such as engine revolution information, or other information, such as information about the temperature in the engine room temperature, may be displayed.

Vehicle display devices according to exemplary embodiments and modified examples of the present disclosure have been explained above. These exemplary embodiments and modified examples may be combined as appropriate, and obviously various modifications may be implemented within a range not departing from the spirit of the present disclosure.

What is claimed is:

1. A vehicle display device comprising:
a switch section configured to switch a vehicle between automated driving and manual driving;
a display section capable of displaying information related to driving assistance and information unrelated to driving assistance on a display region; and
a controller that, in a case in which manual driving has been switched to automated driving by the switch section, controls so as to change a display state of the related information on the display section such that the related information is less visible than the unrelated information.

2. The vehicle display device of claim 1, wherein:
in a case in which manual driving has been switched to automated driving by the switch section, the controller controls to as to make a display region of the related information on the display section smaller than a display region of the related information on the display section prior to automated driving being detected.

3. The vehicle display device of claim 1, wherein:
in a case in which manual driving has been switched to automated driving by the switch section, the controller controls so as to shift a display position of the related information on the display section with respect to a display position of the related information on the display section prior to automated driving being detected.

4. The vehicle display device of claim 1, wherein:
in a case in which manual driving has been switched to automated driving by the switch section, the controller controls so as to lower a display density of the related information on the display section compared to a display density of the related information on the display section prior to automated driving being detected.

5. The vehicle display device of claim 1, wherein:
the display region comprises a first display region where at least one of the related information or the unrelated information is capable of being displayed, and a second display region where the unrelated information is displayed; and
in a case in which manual driving has been switched to automated driving by the switch section, the controller controls so as to expand display of the unrelated information from display in the second display region to also being displayed in the first display region.

6. The vehicle display device of claim 1, wherein:
the display section comprises a touch panel that comprises the display region, and that outputs designating information designating a touched location; and
in a case in which manual driving has been switched to automated driving by the switch section and the designating information has been input to the controller from a location where the related information is displayed on the touch panel, the controller controls so as to interrupt display at the location where the related information is being displayed.

7. The vehicle display device of claim 1, wherein:
in a case in which automated driving has been switched to manual driving by the switch section, the controller controls so as to change a display state of the related information on the display section such that the related information during manual driving is more visible than the related information during automated driving.

8. A vehicle display method comprising:
displaying, by a display section, information related to driving assistance and information unrelated to driving assistance on a display region;
determining whether or not a switch section has switched manual driving to automated driving; and
in a case in which the switch section has switched manual driving to automated driving, controlling so as to change a display state of the related information on the display section such that the related information is less visible than the unrelated information.

9. A non-transitory storage medium storing a program that causes a computer to execute a vehicle display processing, the processing comprising:
displaying, by a display section, information related to driving assistance and information unrelated to driving assistance on a display region;
determining whether or not a switch section has switched manual driving to automated driving; and
in a case in which the switch section has switched manual driving to automated driving, controlling so as to change a display state of the related information on the display section such that the related information is less visible than the unrelated information.
